(19) United States
(12) Patent Application Publication
(10) Pub. No.: US 2005/0255214 A1
(43) Pub. Date: Nov. 17, 2005

(54) Method and plant for treating biological liquids, particularly milk and its derivates

(76) Inventors: Antonio Polato, Mussolente (IT); Renzo Gamberini, Bologna (IT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/517,005

(22) PCT Filed: Jul. 24, 2003
(86) PCT No.: PCT/IB03/02952

§ 371 Date: Dec. 6, 2004

(30) Foreign Application Priority Data
Jul. 24, 2002 (IT) VI2002A000166

(51) Int. Cl. A23C 1/00

(52) U.S. Cl. 426/580

(57) ABSTRACT

Method for treating unpackaged biological liquids, particularly milk or its derivatives, having a microbacterial and spore content, comprising the following operative steps: a) separating the biological liquid into a fatty fraction having a higher concentration of fatty matter and a non-fatty fraction having a lower concentration of fatty matter compared to the initial concentration; b) heat treating the non-fatty fraction; c) cooling the non-fatty fraction to a temperature close to the storage temperature (Tc); d) preheating the fatty fraction to a predefined temperature (Ts); irradiating the fatty fraction with electromagnetic radiation for a predefined time (tᵢᵣᵣ); f) cooling the fatty fraction to a temperature close to the storage temperature (Tc); g) mixing the individually treated fractions so as to reconstitute said biological liquid. The electromagnetic radiation is in the range of radio-frequencies having frequencies of less than 1 GHz.

### FIELD OF APPLICATION

The present invention relates to a method and a plant for treating biological liquids, particularly milk or its derivatives.

### STATE OF THE ART

Biological liquids, particularly but not exclusively intended for human consumption, must be sold under guaranteed hygiene and conservation conditions, as determined by specific regulations laid down by national legislation.

In the case of milk and its derivatives, the treatment processes for hygienic preparation of said products are generally thermal in nature. Said processes result in the destruction or at least a reduction in the bacterial content as a result of the effect of temperature maintained for an appropriate treatment time.

Pasteurisation and sterilisation are examples of treatment processes.

Pasteurisation results in the destruction of the pathogenic content. This allows the milk to be consumed in a suitably hygienic condition but only guarantees its conservation for a short time, from 2 to 8 days depending on the treatment, and exclusively in a cooled environment.

With sterilisation, all the bacterial content is destroyed and a product which can be kept for longer is obtained.

Continuous methods commonly known as UHT (Ultra High Temperature), in which the milk is heated to temperatures of between 135 and 150° C. and kept at these temperatures for a time period of between 3 and 20 seconds, form part of this last group of processes.

Milk which is treated with these processes has a shelf life at room temperature of over three months.

On the hand, all the abovementioned heat treatment methods degrade the components of milk, reducing its nutritional value and producing compounds responsible for aromas or flavours which are unpleasant for the consumer.

Typical manifestations of a reduction in the intrinsic value of the milk consist in browning of the colour, due to compounds which are formed from the sugars, and the presence of a baked taste. These degradation phenomena are correspondingly more pronounced with an increase in intensity of the treatment and are commonly referred to by the term “heat damage” affecting milk.

All national regulations relating to the sale of milk and its derivatives impose precise limits on the abovementioned degradation phenomena. These are generally expressed as a maximum limit on denaturing of the seroproteins, and the quality level of the product is classified according to the degree of said degradation.

Considerable efforts have been made to limit the heat damage, with a constant attempt to obtain the desired hygienic state while operating under the lowest thermal stress conditions possible.

EP-B-828,430, in the name of the present Applicant, describes a method for the continuous sterilisation of milk or its derivatives by means of heat treatment followed by irradiation with electromagnetic radiation in the radio-frequency range.

Said radiation has proved to be particularly effective with regard to the bacterial content. Moreover, more effective heating of the whole mass of milk to be treated is obtained by applying energy directly to the molecules, preventing degradation of the part of the liquid which comes into contact with the hot surfaces of the exchanger, thereby helping further improve the effectiveness of the process.

A drawback of said known method consists in the need for a considerable outlay in order to build a new sterilisation plant in the dairy.

A further drawback consists in the high operating cost, since a considerable part of the total energy needed to bring the milk to the desired temperature is supplied in the form of electromagnetic radiation, which is significantly more expensive than traditional thermal energy.

Another drawback consists in the need to adopt expensive systems for protecting the staff from electromagnetic radiation, said protection also being necessary because of the size of the plant.

Moreover, the method and apparatus described in patent EP-B-828,430 result in the need for considerable restrictions as regards the quality control procedures and the end product.

### DISCLOSURE OF THE INVENTION

The general object of the present invention is that of eliminating the abovementioned drawbacks by providing a method and a plant for treating biological liquids, such as unpackaged milk and/or its derivatives, which results in complete treatment in a reliable manner with limited heat damage.

One object is that of providing a method and a plant which require low investment and simple and cost-effective management.

A further particular object is that of designing a process and an apparatus which have significant flexibility, irrespective of the intensity and duration of the irradiation applied.

These objects as well as others, which will emerge more clearly hereinafter, are achieved by a method for treating unpackaged biological liquids, particularly milk or its derivatives, having a microbacterial and spore content, comprising the following operative steps:
a) separating said biological liquid into a fatty fraction having a higher concentration of fatty matter and a non-fatty fraction having a lower concentration of fatty matter compared to the initial concentration in said biological liquid;
b) heat treating said non-fatty fraction;
c) cooling said non-fatty fraction to a temperature close to the storage temperature Tc;
d) preheating said fatty fraction to a predefined temperature Ts;
e) irradiating said fatty fraction with electromagnetic radiation for a predefined time tᵢᵣᵣ;
f) cooling said fatty fraction to a temperature close to the storage temperature Tc;
g) mixing said individually treated fractions so as to reconstitute said biological liquid.

According to a further aspect of the invention, a plant for implementing the method is envisaged, said plant according to claim 13, comprising:
a) means for separating said biological liquid into a fatty fraction having a higher concentration of fatty matter and a non-fatty fraction having a lower concentration of fatty matter compared to the initial concentration in said biological liquid;
b) means for heat treating said non-fatty fraction;
c) means for cooling said non-fatty fraction to a temperature close to the storage temperature Tc;
d) means for preheating said fatty fraction to a predefined temperature Ts;
e) means for irradiating said fatty fraction with electromagnetic radiation;
f) means for cooling said fatty fraction to a temperature close to the storage temperature Tc;
g) means for re-combining said individually sterilised fractions so as to reconstitute the treated biological liquid.

As a result of this method and plant, which particularly attack the fraction where the microbial content tends to be particularly active, a drastic reduction in said content is effectively obtained while operating under less extreme conditions and therefore restricting the heat damage as a consequence.

Moreover, the majority of the milk to be treated is sterilised using a method and a plant which are already used in the dairy, thereby reducing the initial outlay considerably.

### BRIEF DESCRIPTION OF THE DRAWINGS

Further characteristic features and advantages of the invention will emerge more clearly in the light of the detailed description which follows of a method and plant according to the invention, illustrated by way of a non-limiting example with the aid of the attached plates of drawings in which:

FIG. 1 shows a flowchart of a treatment method according to the invention;

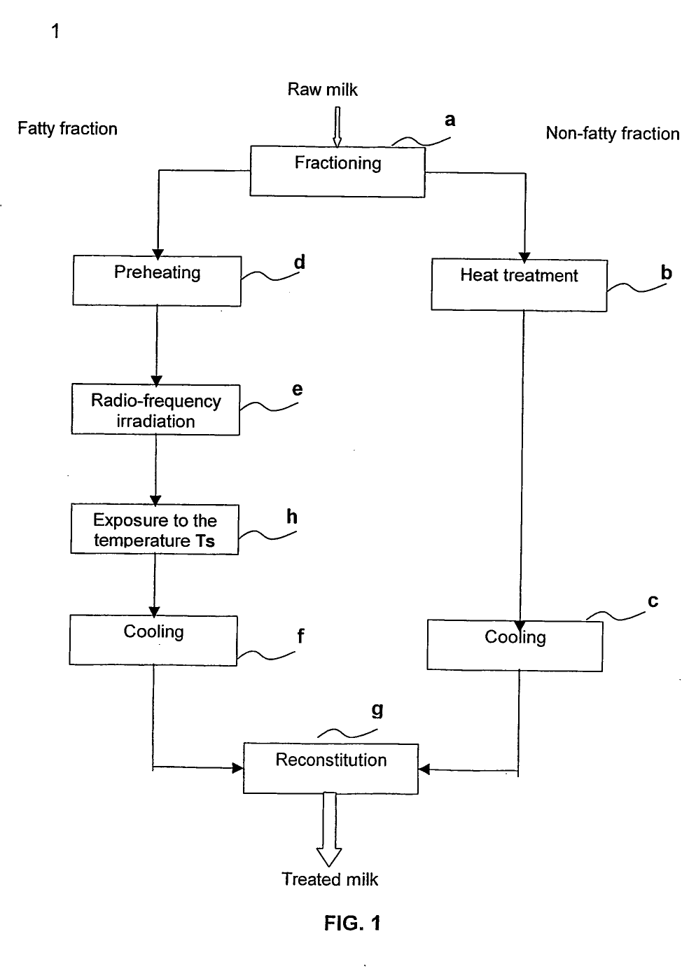

FIG. 2 shows schematically a constructional form of a plant able to implement the method illustrated in FIG. 1.

### DETAILED DESCRIPTION OF A PREFERRED EXAMPLE OF EMBODIMENT

With reference to the attached figures, a flowchart of a preferred but not exclusive example of embodiment of a method according to the invention for treating unpackaged biological liquids containing fatty matter which may be concentrated in a fraction of said liquid, in particular milk or its derivatives, is denoted by reference number 1.

Conveniently, the method operates in continuous flow.

Milk is a very complex liquid which contains, in addition to water, equivalent to about 85% by weight, protein, sugars, mineral salts and fatty matter, the latter being dispersed in the form of globules.

According to the present invention, raw milk to be treated is separated continuously into two distinct fractions, a first fraction, hereinafter called non-fatty fraction, having a lower concentration of fatty matter compared to the raw milk to be treated, and a second fraction, hereinafter called fatty fraction, having a higher concentration of fatty matter, again compared to the raw milk.

Conveniently, the first fraction represents about 90% by weight of the original liquid to be treated and is substantially free from fatty matter.

The fatty fraction, which contains almost all the fatty matter, constitutes approximately the remaining 10% by weight.

Separation processes of this type are commonly used in the food industry and in the milk and cheese-making industry in particular and are within the competence of any person skilled in the art.

According to the invention, the non-fatty fraction and the fatty fraction are subjected to two different processes before being recombined to produce the end product.

In particular, while the non-fatty fraction is subjected to a conditioning heat treatment known per se, followed by relatively rapid cooling to a temperature Tc close to the storage temperature, the fatty fraction is subjected to initial preheating to a predetermined temperature Ts, which may vary according to the types of treatment to be performed on the milk, followed by irradiation with electromagnetic radiation in the radio-frequency range for a predetermined period of time.

More precisely, in the case where the treatment which is to be performed on the milk is pasteurisation, the preheating temperature Ts of the fatty fraction will be between 70° C. and 75° C., and preferably equal to about 72° C.

In the case where the treatment to be carried out on the milk is sterilisation, the preheating temperature Ts of the fatty fraction will be between 140° C. and 150° C., and preferably close to about 145° C.

In the case where the treatment is a special pasteurisation treatment with an increase in the shelf life, for example by means of heating to temperatures of between 90° C. and 125° C., the preheating temperature Ts will be between 115° C. and 125° C., and will be preferably close to 120° C.

In the case where it is required to perform the special pasteurisation by means of heating to temperatures of between 80° C. and 100° C., the preheating temperature Ts is between 85° C. and 95° C., and is preferably close to 90° C.

The preheating may be performed indirectly, by means of heat exchangers, usually of the plate type, or directly, by means of the introduction of live steam and subsequent vacuum expansion.

Conveniently, the irradiation time tᵢᵣᵣ with electromagnetic radiation in the radio-frequency range may be between 1 and 5 seconds, and will be preferably close to 1.5 seconds.

Once the irradiation has been completed, the fatty fraction is also cooled rapidly to the conservation temperature Tc.

Once the treatment has been completed, the two fractions, which have been treated separately and then cooled substantially to the same temperature, are mixed so as to reconstitute a treated liquid having the original composition.

Owing to the fact that the use of electromagnetic radiation in the radio-frequency range is restricted to just the fatty fraction, which contains most of the bacteria and/or sporogenic agents, a significant reduction in treatment costs will be obtained, as well as lower heat stressing of the treated product, therefore better protecting its organoleptic properties.

In a particularly preferred embodiment, after irradiation, the fatty fraction is kept at temperatures close to the irradiation temperature Ts for a time t_{w} of between 2 and 5 seconds, preferably close to 3 seconds, so as to complete the destruction of the bacterial content.

Advantageously, the electromagnetic radiation has a frequency of less than 1 GHz. This frequency, effective in destroying the bacterial content, results in the need for protection for the staff who act as ordinary operators.

The heat treatment processes carried out on the non-fatty fraction may be pasteurisation, during which the biological liquid is heated to temperatures of between 60° C. and 80° C. for a period of between 5 and 20 seconds, or sterilisation, with temperatures of between 130° C. and 150° C. for a time of between 2 and 20 seconds.

In order to improve the shelf life, the pasteurisation heat treatment may be performed in more extreme conditions, for example with heating to temperatures of between 80° C. and 90° C. and for a time of between 2 and 20 seconds.

Conveniently, according to a constructional variant, the heat treatment indicated above may be followed by a microfiltration operation, not shown in the accompanying drawings.

According to another embodiment of the present invention, not shown in the drawings, after a first irradiation of the fatty fraction, a second irradiation, preceded by cooling of the fraction so as to prevent excessive superheating of the irradiated product, may be envisaged.

Radio frequencies are particularly effective in destroying the bacteria which find, in the fatty matter, a particularly favourable environment for their growth.

The use of radio frequencies results in the possibility of less aggressive conditions, in particular periods of exposure to high temperatures shorter than those of known methods, and therefore reduces the heat damage, obtaining a product with a better taste or flavour, as well as a more appealing taste for the consumer.

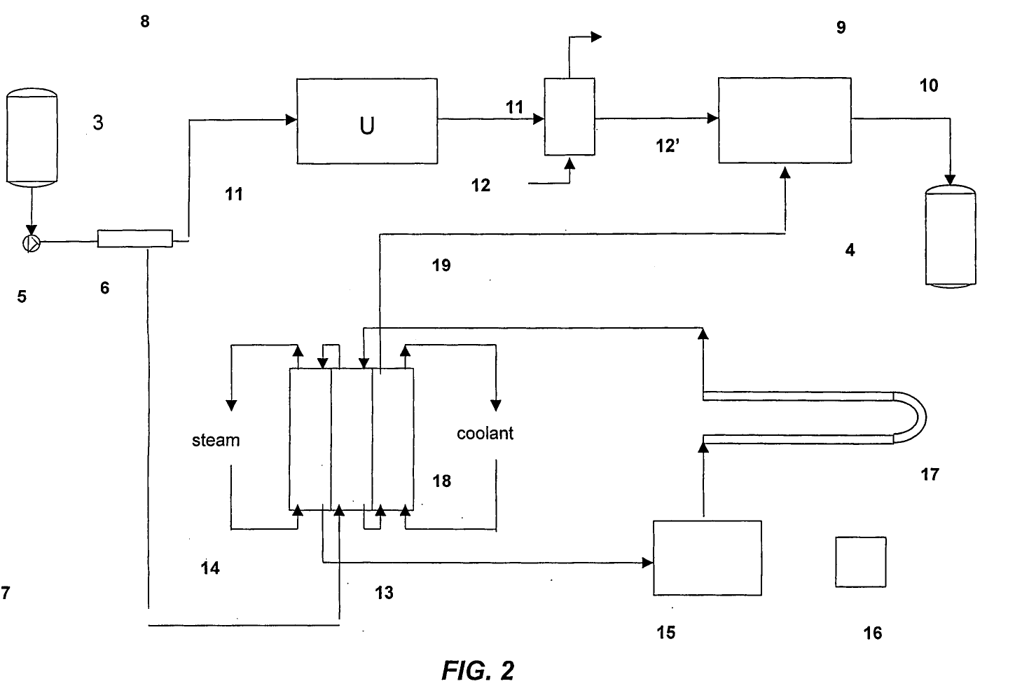

With particular reference to FIG. 2, a plant for implementing the method described above is denoted in its entirety by reference number 2.

The plant 2 comprises a tank 3 for storing the liquid to be treated which is connected to a tank 4 for collecting the treated liquid by means of a hydraulic circuit comprising, in the direction of flow, a circulation pump 5 and a separator 6 for separating the fatty fraction from the non-fatty fraction.

Upstream of the separator 6, the hydraulic circuit is subdivided into a first line, denoted in its entirety by 7, for treating the fatty fraction, and a second line 8 for heat treating the non-fatty fraction.

Both lines join back together in a mixer 9 where the liquid is reconstituted and then conveyed to the collection tank 4 by means of the line 10.

The line 8 comprises, in turn, a heat treatment system U according to the known art which is connected to a cooler 11 by means of the line 12 and to the mixing tank 9 by means of the line 12′. The abovementioned heat treatment may be, pasteurisation or sterilisation respectively, depending on the operating temperature, or forced or special pasteurisation if accompanied by microfiltration.

The line 7 comprises, in the direction of flow, a preheater 13, for example of the plate and counter-flow type, which uses the superheated product itself as a heating fluid, a superheater 14, which is similar to the preheater but which uses a heating fluid, for example water under pressure or steam from an external circuit not shown in the drawings.

An irradiation section, denoted in its entirety by the number 15, an exchanger 17 for storing the fraction at a substantially constant temperature so as to allow the process of destruction of the bacterial content to be completed, and a cooler 18 which uses a cooling fluid kept at about 0° C. by a suitable apparatus not shown in the drawings, are located upstream of the superheater. The liquid cooled to the temperature Tc is conveyed to the mixer 9 by means of a line 19.

The irradiation section 15 may be of the open type, for example with cylindrical symmetry, so as to perform extremely uniform irradiation.

The cylindrical and coaxial sheathing is connected to a triode oscillator 16 or the like which is set to generate radio-frequency waves of less than 1 GHz. The frequency and power of the electromagnetic field are selected on the basis of the composition and the concentration of bacteria present in the product to be treated.

The plant shown by the line 7 in FIG. 2 allows the temperature of the fatty fraction to be increased to values close to the maximum treatment temperature using traditional heat means. Said temperature is reached by means of irradiation with low-power radio waves at relatively low frequencies and for periods of between 1 second and 5 seconds, markedly shorter than those used in traditional heat plants.

The destructive energy used in the form of electromagnetic radiation therefore constitutes a low percentage of the total energy transmitted to the product, reducing the costs of said treatment and the risks which result from using this form of energy.

### EXAMPLE 1

The non-fatty fraction of the milk, which is separated continuously by means of centrifuging and is equivalent to 90% by weight, is heat-treated continuously so as to be sterilised using a UHT method, for example by means of direct heating with steam to 145-150° C. in 3-5 seconds and exposure to 145° C. for 2-3 seconds. The fatty fraction, equivalent to about 10% by weight, is preheated using radio frequencies up to 150° C. in 1.5-2 seconds and kept at the temperature Ts of 150° C. for a time t_{w} of 2-3 seconds.

The milk obtained after reconstituting the two fractions has a shelf life at room temperature of over three months.

### EXAMPLE 2

The non-fatty fraction obtained in the same way as in the preceding example is heat treated by means of pasteurisation with heating to 72° C. in a plate-type exchanger and exposure to 72° C. for 20 seconds. The fatty fraction is preheated to the temperature Ts of 70° C. and is irradiated at this temperature for a time t_{w} of 2 seconds. After reconstitution, milk which is fresh for consumption for up to 4 days is obtained.

### EXAMPLE 3

The non-fatty fraction is heat treated by means of heating to 70° C. in a plate-type exchanger and microfiltration at the same temperature. The fatty fraction is preheated to 70° C. and then subjected to a radio-frequency treatment at the temperature Ts of 70° C. for a time t_{w} of 2 seconds.

### EXAMPLE 4

The non-fatty fraction is heat treated by means of heating to 90° C. in a plate-type exchanger and microfiltration at the same temperature. The fatty fraction is preheated to 100° C. and subjected to a radio-frequency treatment at the temperature Ts of 100° C. for a time t_{w} of 5 seconds. A substantially pasteurised milk with a shelf life of about 8 days in a cooled environment is obtained.

### EXAMPLE 5

The non-fatty fraction is heat-treated by means of heating to 90-120° C. in a plate-type exchanger. The fatty fraction in preheated to 120° C. and subjected to a radio-frequency treatment at the temperature Ts of 120° C. for a time t_{w} of 2 seconds. The milk obtained has an even longer shelf life.

### EXAMPLE 6

Cream which is intended to be sterilised is preheated to 150° C. in 1.5-2 seconds and subjected to a radio-frequency treatment at the temperature of 150° C. for a time t_{w} of 2-3 seconds.

1. A method for treating unpackaged biological liquids, particularly milk or its derivatives, having a microbacterial and spore content, comprising the following operative steps:
a) separating said biological liquid into a fatty fraction having a higher concentration of fatty matter and a non-fatty fraction having a lower concentration of fatty matter compared to the initial concentration;
b) complete conditioning heat treatment of said non-fatty fraction;
c) cooling said non-fatty fraction to a temperature close to the storage temperature;
d) preheating said fatty fraction to a predetermined temperatures;
e) irradiating said preheated fatty fraction with electromagnetic radiation for a predetermined time;
f) cooling said fatty fraction to a temperature close to the storage temperature;
g) mixing said fatty and non-fatty fractions, which have been treated and cooled separately, so as to reconstitute said biological liquid treated at a temperature close to the storage temperature.

2. A method according to claim 1, wherein said electromagnetic radiation is in the radio-frequency range.

3. A method according to claim 2, wherein the radio frequency of said electromagnetic radiation is less than 1 GHz.

4. A method according to claim 2, wherein said irradiation time in said step e) is between 1 second and 5 seconds.

5. A method according to claim 4, wherein said heat treatment step b) comprises sterilisation and the preheating temperature of the fatty fraction is between 140° C. and 150° C.

6. A method according to claim 4, wherein said heat treatment step b) is pasteurisation and the preheating temperature is between 70° C. and 75° C.

7. A method according to claim 4, wherein said heat treatment b) comprises heating to temperatures of between 90° C. and 125° C. and the preheating temperature is between 115° C. and 125° C.

8. A method according to claim 4, wherein said heat treatment step b) comprises heating to temperatures of between 80° C. and 100° C., and the preheating temperature is between 85° C. and 95° C.

9. A method according to claim 1, wherein after said irradiation step e), it comprises a further step h) of exposure to the predefined temperature for a specific time.

10. A method according to claim 9, wherein said time is between 2 and 5 seconds.

11. A method according to claim 1, wherein said steps are performed in conditions of continuous flow of the biological liquid to be treated.

12. A method according to claim 1, wherein said fatty fraction contains substantially all the fatty matter of the biological liquid to be treated.

13. A method according to claim 11, wherein said fatty fraction is about 10% by weight of the biological liquid.

14. A plant for treating unpackaged biological liquids comprising:
a) means for separating said biological liquid into a fatty fraction having a higher concentration of fatty matter and a non-fatty fraction having a lower concentration of fatty matter compared to the initial concentration in said logical liquid.
b) means for heat treating said non-fatty fraction;
c) means for cooling said non-fatty fraction to a temperature close the storage temperature;
d) means for preheating said fatty fraction to a predefined temperature;
e) means for irradiating said fatty fraction with electromagnetic irradiation;
f) means for cooling said fatty fraction to a temperature close to storage temperature;
g) means for mixing said fractions, which have been individually treated and cooled, so as to reconstituted the treated biological liquid.

15. A plant according to claim 14, wherein said irradiation means comprises an oscillator operating in the range of radio frequencies low 1 GHz.

16. A plant according to claim 14, wherein said heat treatment means for heating said non-fatty fraction to a temperature of between 60° C. and 150° C.

17. A plant according to claim 14, wherein said preheating means comprises means for heating said fatty fraction to a temperature of between 60° C. and 150° C.

18. A plant according to claim 14 comprising means for keeping said fatty fraction at the predefined temperature for a time.

19. A method according to claim 4, wherein said irradiation time is about 1.5 seconds.

20. A method according to claim 5, wherein the heat treatment temperature is about 145° C.

21. A method according to claim 6, wherein the preheating temperature is about 72° C.

22. A method according to claim 7, wherein the preheating temperature is about 120° C.

23. A method according to claim 8, wherein the preheating temperature is about 90° C.

24. A method according to claim 10, wherein the time is about 3 seconds.
